(19) United States
(12) Patent Application Publication
(10) Pub. No.: US 2024/0389152 A1
(43) Pub. Date: Nov. 21, 2024

(54) First Wireless Device, Network Node, and Methods Performed Thereby, for Handling Access to a Wireless Communications Network

(71) Applicant: Telefonaktiebolaget LM Ericsson (publ), Stockholm (SE)

(72) Inventors: Andreas Höglund, Solna (SE); Oscar Ohlsson, Bromma (SE)

(21) Appl. No.: 17/917,295

(22) PCT Filed: May 11, 2021
(86) PCT No.: PCT/SE2021/050446

§ 371 Date: Oct. 6, 2022

Related U.S. Application Data
(60) Provisional application No. 63/025,236, filed on May 15, 2020.

(51) Int. Cl. H04W 74/0833; H04W 48/06; H04W 48/12; H04W 74/00; H04W 74/08

(52) U.S. Cl. CPC H04W 74/0833; H04W 48/06; H04W 48/12; H04W 74/002; H04W 74/0866

(57) ABSTRACT

A method performed by a first wireless device (131). The method is for handling access to a wireless communications network (100). The first wireless device (131) sends (403) a first message to a network node (110) as a part of a random access procedure to access the wireless communications network (100). The first wireless device (131) has one or more first features that are limited with respect to one or more second features of one or more second wireless devices (132). The sending (403) is performed according to one or more first parameters. The one or more first parameters are different than one or more second parameters permitted to be used in the wireless communications network (100) by the one or more second wireless devices (132) when performing random access.

### TECHNICAL FIELD

The present disclosure relates generally to a first wireless device and methods performed thereby for handling access to a wireless communications network. The present disclosure also relates generally to a network node, and methods performed thereby for handling the access to the wireless communications network.

### BACKGROUND

Wireless devices within a wireless communications network may be e.g., User Equipments (UE), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, sensors, cameras, Internet of Things (IOT) devices, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, which is a 5G Node B, evolved Node B (“eNB”), “eNodeB”, “NodeB”, “B node”, Transmission Point (TP), or BTS (Base Transceiver Station), depending on the technology and terminology used. The base stations may be of different classes such as e.g., Wide Area Base Stations, Medium Range Base Stations, Local Area Base Stations, Home Base Stations, pico base stations, etc., based on transmission power and thereby also cell size. A cell is the geographical area where radio coverage may be provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G Core Network (CN).

### Internet of Things (IoT)

The Internet of Things (IoT) may be understood as an internetworking of communication devices, e.g., physical devices, vehicles, which may also referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of loT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

### Machine Type Communication (MTC)

Machine Type Communication (MTC) has in recent years, especially in the context of the Internet of Things (IOT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically more simple, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the loT, it is evident that MTC traffic will be increasing and thus needs to be increasingly supported in wireless communication systems.

### Reduced Capability NR Devices

5G is the fifth generation of cellular technology and was introduced in Release 15 of the 3GPP standard. 5G may be understood to be designed to increase speed, reduce latency, and improve flexibility of wireless services. The 5G System (5GS) may be understood to include both a new radio access network, the so-called Next Generation Radio Access Network (NG-RAN), which makes use of a new air interface called New Radio (NR), and a new core network, the 5G Core (5GC).

The initial release of 5G in Release 15 may be understood to be optimized for mobile broadband (MBB) and Ultra-Reliable and Low Latency Communication (URLLC). These services may require very high data rates and/or low latency and therefore may place high requirements on a UE. To enable 5G to be used for other services with more relaxed performance requirements, a new low complexity UE type is introduced in Release 17, see [1]. The REduced CAPability (RedCap) UE type may be understood to be particularly suited for machine type communication (MTC) services, such as wireless sensors or video surveillance, but it may also be used for MBB services with lower performance requirements, such as wearables. The low complexity UE may be understood to have reduced capabilities compared to a Release 15 NR UE, for instance: reduced UE bandwidth, reduced number of UE Receive/Transmit (RX/TX) antennas, half duplex Frequency Division Duplex (FDD), relaxed UE processing time, and/or relaxed UE processing capability.

Because of the reduced capabilities, the low complexity UE may sometimes also be referred to as an NR RedCap UE. An NR RedCap UE may have some or all of the reduced capabilities above.

From the operator side, it may important that the low complexity UEs are only used for their intended use cases. To enforce this requirement, the network may need to be able to identify the low complexity UEs, and be able to restrict their access when necessary. This is captured in the 3GPP study item description for the low complexity UE [1] as a study standardization framework and principles for how to define and constrain such reduced capabilities-considering a definition of a limited set of one or more device types and considering how to ensure that those device types are only used for the intended use cases. This is also captured in the 3GPP study item description for the low complexity UE as a study functionality that may allow devices with reduced capabilities to be explicitly identifiable to networks and network operators, and allow operators to restrict their access, if desired.

In some cases, it may also be desirable for the network to be able to restrict access for the UEs which may be authorized to use reduced capabilities. For example, in case of an overload situation, such as radio resource congestion or shortage of processing capabilities, a network may wish to reduce overload by denying access to a cell for the low complexity UEs. The network may also need to prioritize between normal complexity and low complexity UEs during overload situations. To this end, the network may employ what is in 3GPP referred to as access control.

### Access Control Mechanisms in NR

Access control may be used to prevent overload in wireless networks and ensure that high priority services, such as emergency calls, may gain access to the system also in times of congestion. In NR, there may be multiple access control mechanisms and, which one to use may depend on how severe a certain load situation may be, as illustrated in FIG. 1. During normal operation and light load, regular scheduling may be used to ensure that the Quality of Service (QOS) targets may be met for the UEs in the cell. At higher loads, the network may decide to apply Random Access (RA) backoff or release/reject UEs with a wait timer. Access barring may be typically applied as a last resort when the previous mechanisms may not be enough to reduce the load. While scheduling may be understood to be performed in connected mode, random access backoff, release/reject of UEs and UE Access barring (UAC) may be applied during idle, inactive and or connected modes.

### Random Access

FIG. 2 is a schematic diagram illustrating non-limiting examples of Random Access Procedures of: a) a CBRA with 4-step RA type, b) a CBRA with 2-step RA type, c) a CFRA with 4-step RA type, and d) a CFRA with 2-step RA type, according to existing methods. FIG. 2 corresponds to FIG. 9.2.6-1 from Technical Specification (TS) 38.300, v16.1.0. CBRA may be understood to refer to contention-based random access, and CFRA may be understood to refer to contention-free random access. The latter may be understood to cover the case where a unique preamble/RA resource has been provided to the UE which may be understood to remove the need for contention resolution procedure, typically only used in CONNECTED. When data arrives in the UE data buffer, the random access procedure may be triggered if the UE is in RRC IDLE or RRC INACTIVE state, or in RRC CONNECTED if the UE does not have a Physical Uplink Control Channel (PUCCH) resource to transmit a scheduling request. The UE may then randomly select a preamble (Msg1) in an upcoming Physical Random Access Channel (PRACH) resource, typically the first one to minimize the latency. This may be understood to correspond to step 1 in FIG. 2 a), and the first arrow in step A in FIG. 2 b). The gNB may then respond to the preamble transmission in Msg2, providing an UL grant for the Msg3 transmission, a temporary Cell Radio Network Temporary Identifier (C-RNTI) value to be used, and a Timing Advance value to apply for the UE to obtain uplink synchronization. This may be understood to correspond to step 2 in FIG. 2 a). Msg2 may be carried on a Physical Downlink Shared CHannel (PDSCH) and scheduled dynamically by gNB; the UE may monitor the Physical Downlink Control CHannel (PDCCH) scrambled with a Random Access Radio Network Temporary Identifier (RA-RNTI) during the Random Access Response (RAR) window. If Msg2 is successfully received by the UE, the UE may next transmit Msg3, which may be understood to contain a Radio Resource Control (RRC) message, which may depend on the reason for the access attempt, but e.g., RRCSetupRequest if the UE may want to setup a connection to transmit data, and a UE_ID to identify the UE, or a random value if it is the initial attach of the UE to the network. This may be understood to correspond to step 3 in FIG. 2 a). In Msg4, the network may provide an RRC message response to the UE, in the example above the RRCSetup, with further instructions to the UE. This may be understood to correspond to step 4 in FIG. 2 a). In addition, the UE_ID in Msg3 may be echoed back to the UE as part of the contention resolution. That is, two or more UEs may have selected the same preamble in the same PRACH resource, successfully received Msg2 and also transmitted Msg3, but only the UE who received its UE_ID back in Msg4 may conclude it has won the contention resolution and continue to establish a dedicated connection.

These messages are illustrated in FIG. 2, corresponding to FIG. 9.2.6-1 from TS 38.300, v16.1.0. In the CBRA with 2-step RA type illustrated in panel b), the payload may be sent by the UE in step A, together with the RA Preamble. The Contention Resolution may then be performed in step B, so that the whole procedure is performed in two steps. In FIG. 2 c) and d), the preamble assigned to the UE by the gNB in step 0, may be sent back to the gNB by the UE in step 1 and A, respectively. In the CFRA with 2-step RA type illustrated in panel d), the payload may be sent by the UE in step A, together with the RA Preamble. The Random Access Response may then be sent by the gNB in step 2 and step B, respectively.

The UE behavior upon failure may depend on in which step the UE may fail. If Msg2 is not received, the UE may assume that the gNB could not successfully decode Msg1 and may perform a re-attempt with increased power, e.g., an open-loop power control. The UE may count the number of attempts, and after a configurable maximum number of attempts has been reached, it may conclude that the random access procedure has failed and communicate this to higher layers in the UE. If Msg4 is not received, the UE may attempt Msg3 Hybrid Automatic Repeat reQuest (HARQ) retransmission. Finally, if Msg4, is received but not containing the UEs own UE_ID it may conclude that it lost the contention resolution and may start over from Msg1 preamble transmission.

Existing methods to perform random access to a network may cause unnecessary delays, signalling overhead, and waste of processing and energy resources, resulting in a low performance of the network, and unsatisfactory user experience.

### SUMMARY

As part of the development of embodiments herein, one or more challenges with the existing technology will first be identified and discussed.

For some access restriction mechanisms it is not possible to distinguish and treat reduced capability UEs separately.

It is an object of embodiments herein to improve the handling access to a wireless communications network. Particularly, it may be understood to be an object of embodiments herein to improve the handling of access to a wireless communications network by a wireless device with limited features.

According to a first aspect of embodiments herein, the object is achieved by a method, performed by a first wireless device. The method is for handling access to a wireless communications network. The first wireless device sends a first message to a network node as a part of a random access procedure to access the wireless communications network. The first wireless device has one or more first features that are limited with respect to one or more second features of one or more second wireless devices. The sending is performed according to one or more first parameters. The one or more first parameters are different than one or more second parameters permitted to be used in the wireless communications network by the one or more second wireless devices when performing random access.

According to a second aspect of embodiments herein, the object is achieved by a method, performed by the network node. The method is for handling access to the wireless communications network. The network node receives the first message from the first wireless device as a part of the random access procedure to access the wireless communications network. The first wireless device has the one or more first features that are limited with respect to the one or more second features of the one or more second wireless devices. The receiving is performed according to one or more first parameters. The one or more first parameters are different than the one or more second parameters permitted to be used in the wireless communications network by the one or more second wireless devices when performing random access.

According to a third aspect of embodiments herein, the object is achieved by the first wireless device, for handling the access to the wireless communications network. The first wireless device is configured to send the first message to the network node as a part of the random access procedure to access the wireless communications network. The first wireless device is configured to have the one or more first features that are configured to be limited with respect to the one or more second features of the one or more second wireless devices. The sending is configured to be performed according to the one or more first parameters. The one or more first parameters are configured to be different than the one or more second parameters configured to be permitted to be used in the wireless communications network by the one or more second wireless devices when performing random access.

According to a fourth aspect of embodiments herein, the object is achieved by the network node, for handling the access to the wireless communications network. The network node is configured to receive the first message from the first wireless device as a part of the random access procedure to access the wireless communications network. The first wireless device is configured to have one or more first features that are configured to be limited with respect to the one or more second features of the one or more second wireless devices. The receiving is configured to be performed, according to the one or more first parameters. The one or more first parameters are configured to be different than the one or more second parameters configured to be permitted to be used in the wireless communications network by the one or more second wireless devices when performing random access.

By sending the first message to the network node according to the one or more first parameters, the random access procedure to access the wireless communications network 100 may be enabled to be more restrictive to the first wireless device, e.g., a RedCap UE, in comparison the one or more second wireless devices, which may be non-limited. This may be understood to enable to protect or prioritize the performance of legacy or normal capability wireless devices. This may therefore enable that in case of an overload situation, such as radio resource congestion or shortage of processing capabilities, the network node may be enabled to reduce overload by denying access to a cell to low complexity UEs such as the first wireless device. Hence, the performance of the wireless communications network may be optimized, ensuring that service to higher priority wireless devices is provided.

### BRIEF DESCRIPTION OF THE DRAWINGS

Examples of embodiments herein are described in more detail with reference to the accompanying drawings, according to the following description.

FIG. 1 is a schematic diagram illustrating an overview of access control mechanisms in NR, according to existing methods.

FIG. 2 is a schematic diagram illustrating non-limiting examples of Random Access Procedures of: a) a CBRA with 4-step RA type, b) a CBRA with 2-step RA type, c) a CFRA with 4-step RA type, and d) a CFRA with 2-step RA type, according to existing methods.

FIG. 3 is a schematic diagram an example of a wireless communications network, according to embodiments herein.

FIG. 4 is a flowchart depicting a method in a first wireless device, according to embodiments herein.

FIG. 5 is a flowchart depicting a method in a network node, according to embodiments herein.

FIG. 6 is a schematic block diagram illustrating two embodiments, in panel a) and panel b), of a first wireless device, according to embodiments herein.

FIG. 7 is a schematic block diagram illustrating two embodiments, in panel a) and panel b), of a network node, according to embodiments herein.

FIG. 8 is a schematic block diagram illustrating a telecommunication network connected via an intermediate network to a host computer, according to embodiments herein.

FIG. 9 is a generalized block diagram of a host computer communicating via a base station with a user equipment over a partially wireless connection, according to embodiments herein.

FIG. 10 is a flowchart depicting embodiments of a method in a communications system including a host computer, a base station and a user equipment, according to embodiments herein.

FIG. 11 is a flowchart depicting embodiments of a method in a communications system including a host computer, a base station and a user equipment, according to embodiments herein.

FIG. 12 is a flowchart depicting embodiments of a method in a communications system including a host computer, a base station and a user equipment, according to embodiments herein.

FIG. 13 is a flowchart depicting embodiments of a method in a communications system including a host computer, a base station and a user equipment, according to embodiments herein.

### DETAILED DESCRIPTION

Certain aspects of the present disclosure and their embodiments may provide solutions to the challenges described in the Background and Summary sections herein, or other challenges. Particular embodiments herein may be generally understood to relate to different aspects of providing restricted Random Access for reduced capability NR devices. Embodiments herein may be understood to enable that reduced capability (RedCap) UEs may be distinguished in the random access procedure, and more restrictive access may be applied for the RedCap UEs, as compared to legacy/normal capability UEs. That is, configuration parameters for the random access, e.g., the random back-off time or maximal number of attempts may be configured to be more restrictive for RedCap UEs to give them lower priority in the random access procedure.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

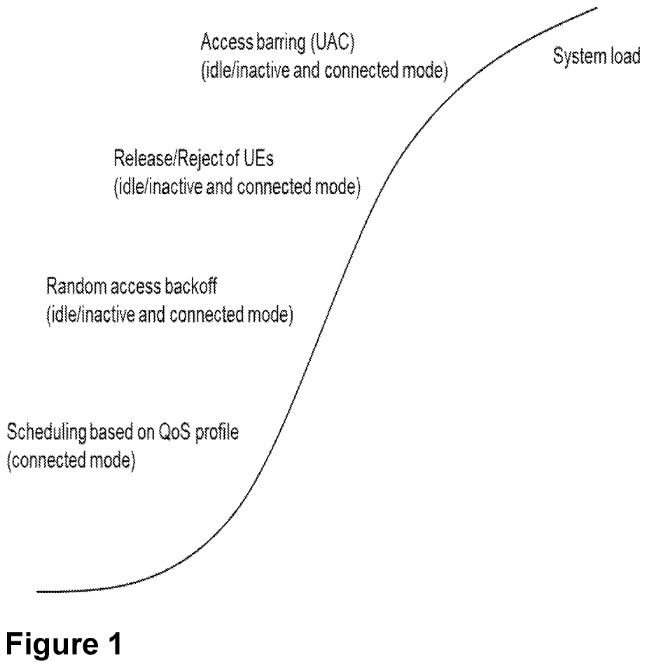

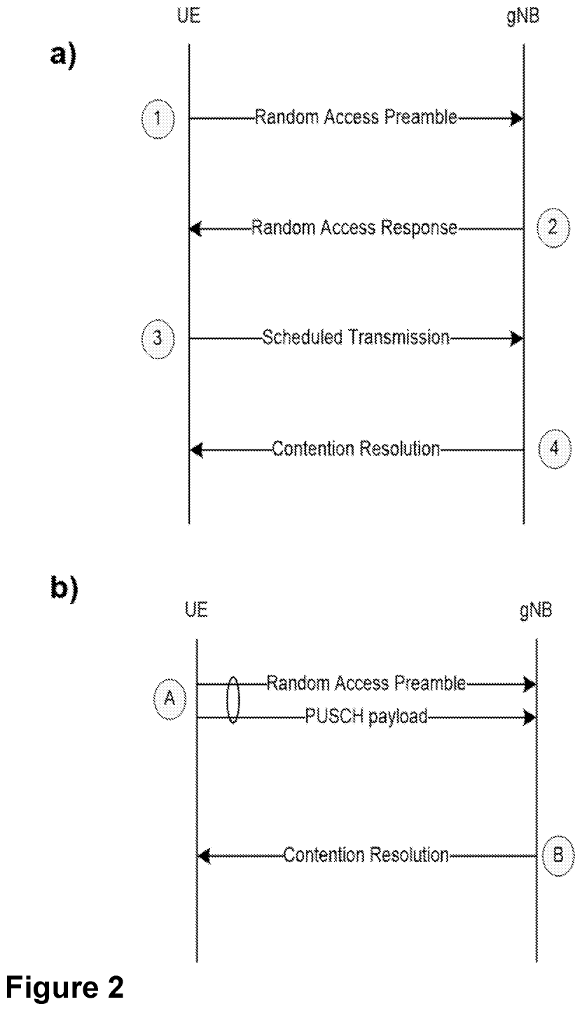

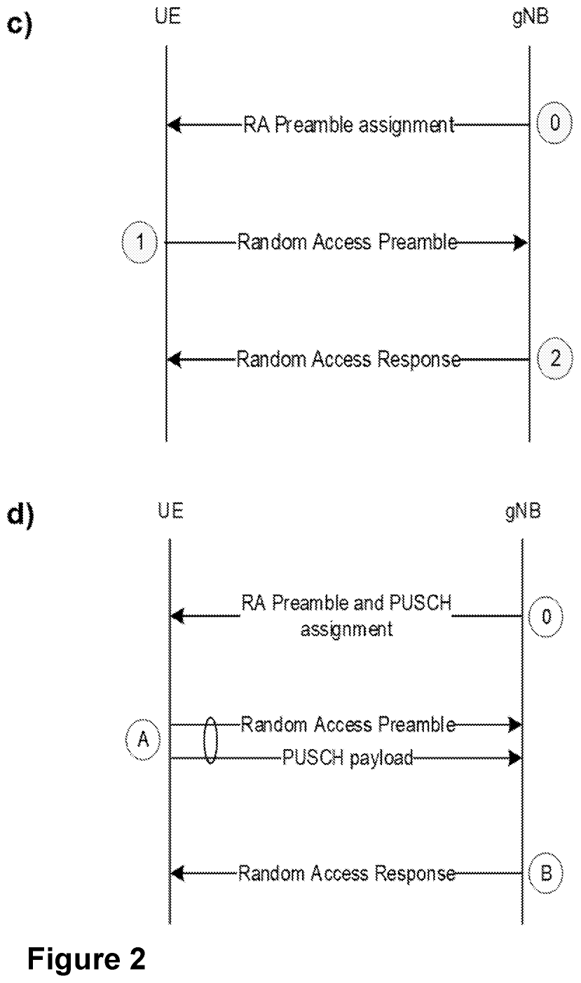

FIG. 1 depicts two non-limiting examples of a wireless network or wireless communications network 100, sometimes also referred to as a wireless communications system, cellular radio system, or cellular network, in which embodiments herein may be implemented. The wireless communications network 100 may typically be support MTC, eMTC, IoT and/or NB-IoT. The wireless communications network 100 may be a 5G system, 5G network, or Next Gen System or network. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE LAA, eLAA, feLAA and/or MulteFire. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 1. The network node 110 is a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 1 b, the network node 110 may be a distributed node, and may partially perform its functions in collaboration with a virtual node 116 in a cloud 115.

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the communications network 100 may be directly connected to one or more core networks.

A plurality of wireless devices may be located in the wireless communication network 100, whereof a first wireless device 131 and one or more second wireless devices 132 are depicted in the non-limiting example of FIG. 1. Any of the first wireless device 131 and the one or more second wireless devices 132 comprised in the wireless communications network 100 may be a wireless communication device such as a 5G UE, or a UE, which may also be known as e.g., mobile terminal, wireless terminal and/or mobile station, a mobile telephone, cellular telephone, a sensor, IoT device, NB-IoT device, device equipped with a wireless interface, such as a printer or a file storage device, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, modem, or any other radio network unit capable of communicating over a radio link in a communications system. Any of the first wireless device 131 and the one or more second wireless devices 132 comprised in the wireless communications network 100 may be enabled to communicate wirelessly in the wireless communications network 100. The communication may be performed e.g., via a RAN, and possibly the one or more core networks, which may comprised within the wireless communications network 100.

The first wireless device 131 may have one or more first features that may be understood to be limited with respect to one or more second features of one or more second wireless devices 132. In particular embodiments, the first wireless device 131 may be a RedCap UE. The one or more second wireless devices 132 may be referred to herein as legacy or full, non-reduced capability UEs.

The first wireless device 131 may belong to a first group, type or category of wireless devices, whereas the one or more second wireless devices 132 may belong to a second group, type or category of wireless devices.

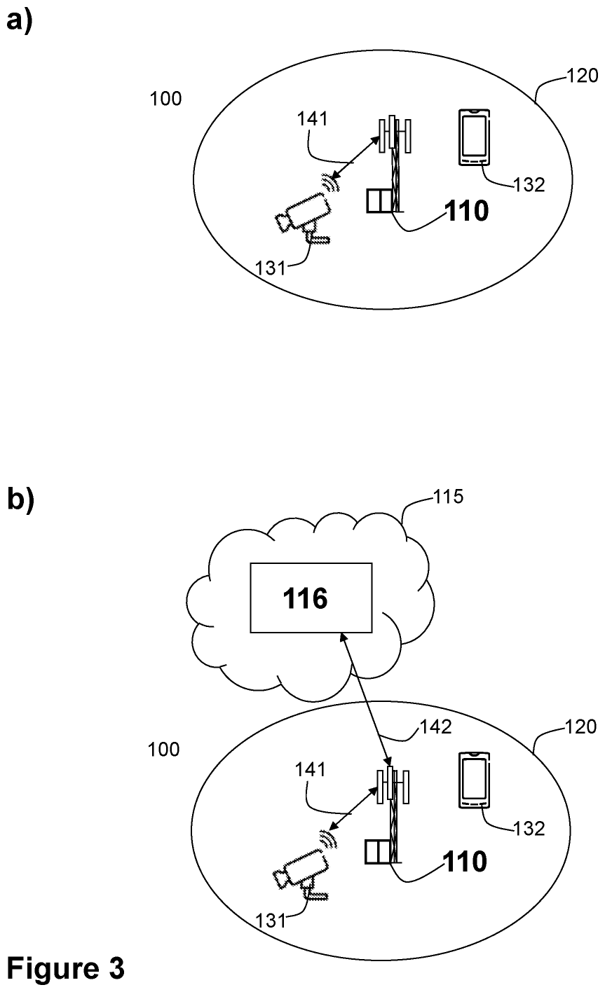

It may be understood that while in FIG. 3 the one or more wireless devices 132 are depicted as being comprised in the cell 120, this may be understood to be for illustration purposes only, and may not be necessarily the case.

The first wireless device 131 may be configured to communicate within the wireless communications network 100 with the network node 110 over a first link 141, e.g., a radio link. The network node 110 may be configured to communicate within the wireless communications network 100 with the virtual network node 116 over a second link 142, e.g., a radio link or a wired link. The one or more second wireless devices 132 may be configured to communicate within the wireless communications network 100 with the network node 110 over a respective link, e.g., a radio link, which is not depicted in FIG. 3 to simplify the figure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, fourth and/or “fifth” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the first wireless device 131, e.g., a 5G UE,or a UE, and embodiments related to a network node, such as the network node 110, e.g., a gNB or an eNB.

Some embodiments herein may be further described with some non-limiting examples.

In the following description, any reference to a/the UE, UEs, RedCap UEs, RedCap UE, or simply “UE” may be understood to equally refer to the first wireless device 131, unless a reference to a/the legacy UE(s) is made; any reference to a/the gNB, a/the NW and/or a/the network may be understood to equally refer to the network node 110; any reference to a/the legacy or full, non-reduced capability UEs may be understood to equally refer to the one or more second wireless devices 132.

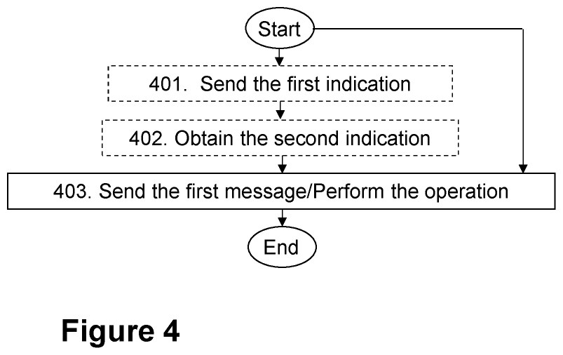

Embodiments of a method, performed by the first wireless device 131, will now be described with reference to the flowchart depicted in FIG. 4. The method may be understood to be for handling access to a wireless communications network. The first wireless device 131 may be understood to operate in the wireless communications network 100.

In some examples, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may be understood to be a computer-implemented method.

Several embodiments are comprised herein. The method may comprise one or more of the following actions. In some embodiments, all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first wireless device 131 is depicted in FIG. 4.

In FIG. 4, optional actions are represented with dashed lines.

### Action 401

In order for the network node 110 to be able to perform access control of limited devices, the network node 110 may need to first know which devices may be limited or not.

In accordance with the foregoing, in this Action 401, the first wireless device 131 may send a first indication to the network node 110. The first indication may indicate that the first wireless device 131 has one or more first features that are limited with respect to one or more second features of one or more second wireless devices 132.

The one or more second wireless devices 132 may be understood to be legagy, non-limited devices. In some particular embodiments, the first wireless device 131 may be a wireless device with reduced capacity, e.g., a RedCap UE. The one or more features may be, for instance, reduced UE bandwidth, reduced number of UE Receive/Transmit (RX/TX) antennas, half duplex Frequency Division Duplex (FDD), relaxed UE processing time, and/or relaxed UE processing capability.

The sending in this Action 403 may be performed, e.g., via the first link 141.

The first indication may be for example, a capability indication.

By sending the first indication in this Action 401, the first wireless device 131 may enable the network node 110 to know that the first wireless device 131 is a limited device, and hence, it may enable the network node 110 to apply random access control over the first wireless device 131.

### Action 402

In this Action 402, the first wireless device 131 may obtain a second indication from at least one of the network node 110 and a memory of the first wireless device 131. The second indication may indicate at least one of: one or more first parameters, and one or more conditions.

The one or more first parameters may be to be used by the first wireless device 131, in Action 403, to send a first message as a part of a random access procedure to access the wireless communications network 100. The one or more parameters may be different than one or more second parameters permitted to be used in the wireless communications network 100 by the one or more second wireless devices 132 when performing random access. The one or more first parameters may be understood to cover different ways in which the random access procedure may be made more restrictive for RedCap UEs.

In a first example of embodiments herein, the random access procedure may be differentiated for RedCap UEs and other UEs, e.g., legacy or full, non-reduced capability UEs. For example, a separate RedCap configuration for random access may be provided via RRC signaling to UEs which may need to be applied by RedCap UEs. That is, alternative configuration parameters may be provided for RedCap in e.g., the RACH or PRACH configuration, and these parameters may need to be applied by RedCap UEs instead of the legacy parameters.

The one or more first parameters, in relation to the one or more second parameters may comprise at least one of the following options.

i. Fewer Preambles

According to a first option, the one or more second parameters may comprise a smaller group of preambles to select from, to transmit to the network node 110, e.g., for Msg1 transmission. In one example, RedCap UEs may be restricted to use fewer preambles compared to other UEs. This may be an artificial limitation for RedCap UEs, leaving some preambles unused by RedCap UEs and hence providing a lower collision rate for legacy/other UEs.

ii. Smaller Preamble Space for Msg1 Transmission

According to a second option, similarly to the first option, the one or more second parameters may comprise a shorter preamble space for Msg1 transmission to the network node 110. The preamble space may be understood to refer to a set of preambles or preamble indexes available for the Msg1 transmission.

iii. More Infrequent PRACH Resources

According to a third option, the one or more second parameters may comprise more infrequent PRACH resources. In one example, RedCap UEs may be restricted to use a reduced number of PRACH resources compared to other UEs. This may be an artificial limitation for RedCap UEs, e.g., limiting RedCap UEs to be able to use only every second PRACH resource in time, leaving some PRACH resources unused by RedCap UEs, and hence providing a lower collision rate for legacy/other UEs.

iv. Longer Back-Off Time

According to a fourth option, the one or more second parameters may comprise a longer back-off time. In one example, a longer back-off timer may be applied for RedCap UEs, as compared to other UEs upon a failed random access attempt. That is, a longer time may need to pass before a re-attempt may be made. This parameter may not be configured via RRC as many others, but may instead be defined in the procedure text of TS 38.321, v. 16.0.0 by the parameter PREAMBLE_BACKOFF. The principle may be that the value may be initially set to 0 ms, but then may increase with the number of preamble collisions to make the network able to handle congestions situations better. The differentiation for RedCap UEs may e.g., be achieved by the following modification to the procedure text, additions are marked with underlined font:
1> set the PREAMBLE_BACKOFF to 0 ms, or for RedCap UE set the PREAMBLE BACKOFF to 10 ms;

Unlike for LTE, there may be understood to be in NR already a scaling factor to prioritize random access for certain cases, e.g., in 2-step RACH, beam recovery, etc., and in one example the reverse logic may be applied here to instead de-prioritize the random access for RedCap UEs.
2> if the Random Access Response contains a MAC subPDU with Backoff Indicator:
3> set the PREAMBLE_BACKOFF to value of the BI field of the MAC subPDU using Table 7.2-1, multiplied with SCALING_FACTOR_BI.

### Where,

5> set SCALING_FACTOR_BI to the scalingFactorBI.

The addition may be to introduce longer scaling factor for RedCap to protect the legacy UEs:

### RA-Prioritization Information Element

-- ASN1START
-- TAG-RA-PRIORITIZATION-START

| | |
|---|---|
| RA-Prioritization ::= | SEQUENCE { |
| powerRampingStepHighPriority | ENUMERATED {dB0, dB2, dB4, dB6}, |
| scalingFactorBI | ENUMERATED {zero, dot25, dot5, dot75} |

```
OPTIONAL, -- Need R
  ...,
  [[
```

| | |
|---|---|
| scalingFactorBIredcap | ENUMERATED {two, four, eight, sixteen} |

]]
}
-- TAG-RA-PRIORITIZATION-STOP
-- ASN1STOP

RA-Prioritization field descriptions

powerRampingStepHighPrioritiy
Power ramping step applied for prioritized random access procedure.
scalingFactorBI
Scaling factor for the backoff indicator (BI) for the prioritized random access procedure.
(see TS 38.321 [3], clause 5.1.4). Value zero corresponds to 0, value dot25 corresponds to 0.25 and so on.
scalingFactorBIredcap
Scaling factor for the backoff indicator (BI) for the de-prioritized random access procedure.
(see TS 38.321 [3], clause 5.X.X). Value two corresponds to 2, value four corresponds to 4 and so on.

The use of scalingFactorBIredcap may optionally be connected to the use of a new Access Identity or Access Category for RedCap.

v. Lower Number Maximal Number or RA Attempts

According to a fifth option, the one or more second parameters may comprise a lower maximal number of RA attempts.

In one example, a lower number of RA attempts may be configured for RedCap UEs, e.g. using differentiation for the parameter preamble TransMax, see example implementation below in Section 5.3 ‘Configuration aspects’. In congestion situations, this may reduce the interference and collision rate for other/legacy UEs caused by RedCap UEs.

Alternatively, the max number of RA attempts using 2-step RACH, configured by the parameter msgA-TransMax may be lower for RedCap UEs.

vi. Reduced Power Control

According to a sixth option, the one or more second parameters may comprise a reduced power control.

In one example of embodiments herein, the random access power control may be configured such that RedCap UEs may effectively transmit at a relatively lower power than other UEs. This may e.g., be achieved by RedCap UEs starting at lower initial transmit power, that is, with a lower setting for the parameter preambleReceivedTargetPower. Alternatively, the step size for the power ramp-up may be smaller than for other UEs, applying a separate powerRampingStep for 4-step RACH or msgA-PreamblePowerRampingStep for 2-step RACH, or the step-up more infrequent in time.

A first example of configuration may be using a separate RRC configuration for RedCap, e.g., added to the generic RRC configuration, see the added parameters in the example under the Section herein entitled ‘Configuration aspects’, where a different target power and step size may be configured for RedCap. A similar addition may be done in a new RACH-ConfigCommonRedcap configuration. Alternatively, the power ramping step, or other parameters, may be configured as an extension of the RA-Prioritization as shown below, where the additions are marked with underlined text:

### RA-Prioritization Information Element

-- ASN1START
-- TAG-RA-PRIORITIZATION-START

| | |
|---|---|
| RA-Prioritization ::= | SEQUENCE { |
| powerRampingStepHighPriority | ENUMERATED {dB0, dB2, dB4, dB6}, |
| scalingFactorBI | ENUMERATED {zero, dot25, dot5, dot75} |

```
OPTIONAL, -- Need R
  ...,
  [[
```

| | |
|---|---|
| powerRampingStepHighPriorityRedcap | ENUMERATED {dB0, dB2, dB4, dB6} |

]]
}
-- TAG-RA-PRIORITIZATION-STOP
-- ASN1STOP

vii. Indication of Lower Priority

According to a seventh option, the one or more second parameters may comprise a lower priority for being granted access, e.g., A ‘RedCap UE’ indication in Msg3, to be able to prioritize other UEs.

In one example, a RedCap UEs may need to include a RedCap indication in Msg3. With the use of this new indication, a gNB may prioritize and decide how/if to respond with Msg4. For example, if both a RedCap UE and a legacy UE has selected the same preamble in the same

PRACH resource and according to UL grant received in Msg2 also transmitted Msg3, the gNB may prioritize the legacy UE in the contention resolution. That is, if the gNB successfully decodes both Msg3 transmissions it may choose to prioritize and respond to that from the legacy UE, and hence the RedCap UE may lose the contention resolution.

For example, the spare bit in RRCSetupRequest may be used for this purpose, where the additions are marked with underlined text:

### RRCSetupRequest Message

-- ASN1START
-- TAG-RRCSETUPREQUEST-START

| | |
|---|---|
| RRCSetupRequest ::= | SEQUENCE { |
| rrcSetupRequest | RRCSetupRequest-IEs |

}

| | |
|---|---|
| RRCSetupRequest-IEs ::= | SEQUENCE { |
| ue-Identity | InitialUE-Identity, |
| establishmentCause | EstablishmentCause, |
| [symbol] | [symbol] |
| RedCapIndication | ENUMERATED {true} |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, mo-Signalling, |
| | mo-Data, mo-VoiceCall, mo-VideoCall, mo-SMS, mps- |

PriorityAccess, mcs-PriorityAccess,

spare6, spare5, spare4, spare3, spare2, spare1}

-- TAG-RRCSETUPREQUEST-STOP
-- ASN1STOP

viii. A Lower Max Number of Msg3 Transmissions

According to an eighth option, the one or more second parameters may comprise a lower maximum number of Msg3 transmissions, e.g., a lower max number of Msg3 HARQ re-transmissions.

In one example, a lower number of HARQ retransmissions may be configured or applied for RedCap UEs. This may also be solved by network implementation.

In an alternative example of the above, the one or more first parameters, e.g., the differentiated RedCap parameters for random access, may instead be defined as an offset or a factor of the legacy parameter value. This may either be configured via RRC, or hard-coded in specification. In an example of the latter, RedCap UEs may apply the double value, or any other factor/offset, of the back-off time compared to other UEs. This may in a congestion situation make RedCap UEs stay away for longer, and therefore ensure that legacy/other UEs may be prioritized. The principle may be understood to be the same also for other parameters.

According to the foregoing, in some embodiments the one or more first parameters may be indicated as one of: absolute one or more values, one or more offsets of other one or more values, e.g., an offset relative to the legacy parameter values, and one or more factors to apply to the other one or more values. A factor may be, e.g., a scaling factor, such as, a hard-coded scaling factor relative to the legacy parameter values.

### Configuration Aspects

The second indication may be understood as a configuration, which may be either preconfigured in the first wireless device 131 and retrieved from a memory of the first wireless device 131, or signalled by the network node 110.

In the second case, the obtained second indication may be comprised in an RRC configuration message. The second indication may be comprised in one of: a RACH-ConfigCommonRedcap information element (IE), an RA-Prioritization IE, a RACH-ConfigGeneric IE, and an RRCSetupRequest message.

As a particular example, the new differentiated and separate RedCap configuration parameters may be provided to the first wireless device 131 in different ways, e.g. the following: a) hard-coded scaling or offset relative to the legacy parameter values, b) in new RRC config RACH-ConfigCommonRedcap, e.g., including PRACH configuration, configuration index, or configuration restrictions, to indicate the resources are to be used for RedCap, c) as an extension of RA-Prioritization, see examples above under power control and back-off time, and d) in an extension of RACH-ConfigGeneric, see an example below, where the additions are marked with underlined text.

### RACH-ConfigGeneric Information Element

-- ASN1START
-- TAG-RACH-CONFIGGENERIC-START

| | |
|---|---|
| RACH-ConfigGeneric ::= | SEQUENCE { |

| | |
|---|---|
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

```
  ...,
  [[
```

| | |
|---|---|
| ra-ResponseWindow-r16 | ENUMERATED {sl1, sl2, sl4, sl8, sl10, sl20, sl40, sl60, sl80, |

sl160} OPTIONAL, -- Need R

| | |
|---|---|
| prach-ConfigurationIndex-v16xy | INTEGER (256..262) |

```
OPTIONAL -- Need R
  ]],
  [[
```

| preambleReceivedTargetPowerRedcap | INTEGER (−202..−60), |
|---|---|
| preambleTransMaxRedcap | ENUMERATED {n3, n4, n5, n6, n7, n8, n10, n20, n50, |
| | n100, n200}, |
| powerRampingStepRedcap | ENUMERATED {dB0, dB2, dB4, dB6}, |

]]
}
-- TAG-RACH-CONFIGGENERIC-STOP
-- ASN1STOP

The one or more conditions may be conditions based on which the sending of the first message may be sent later, in Action 403, and may comprise a load of the network node 110 or the wireless communications network 100 at the time of performing the random access procedure. For example, the access control may only be applied when the load of the network node 110 or the wireless communications network 100 at the time of performing the random access may be high, that is, may exceed a certain threshold, and not otherwise.

By obtaining the second indication in this Action 402, the first wireless device 131 may be enabled to then send the first message, in the next Action 403 using ehe one or more parameters, which may in turn enable to control that the random access procedure may be made more restrictive for the first wireless device 131, e.g., a RedCap UEs, than for the one or more second wireless devices 132, which may be non-limited.

### Action 403

The first wireless device 131 may, in this Action 403, initiate performing or perform, an operation, e.g., a first operation, as part of a random access procedure to access the wireless communications network 100. As an example, this Action may comprise that the first wireless device 131 sends the first message to the network node 110 as a part of a random access procedure to access the wireless communications network 100. The first wireless device 131 has one or more first features that are limited with respect to one or more second features of one or more second wireless devices 132. The sending in this Action 403 is performed according to the one or more first parameters. As stated earlier, the one or more first parameters are different than the one or more second parameters permitted to be used in the wireless communications network 100 by the one or more second wireless devices 132 when performing random access. The one or more second parameters may be referred to herein as legacy parameters.

The first message in the RA procedure may be, for example, any of an Msg1, MsgA, and/or Msg3.

It may be, for example, that the one or more first parameters are different than the one or more second parameters so that RA by the one or more second wireless devices 132 may be configured to prioritized, e.g., always prioritized, over RA by the first wireless device 131. For example, the sending in this Action 403 may be performed based on the second indication indicating that RA by the one or more second wireless devices 132 is configured to be prioritized, e.g., always prioritized, over RA by the first wireless device 131.

In some embodiments, the sending in this Action 403 may be performed based on one or more conditions. The one or more conditions may comprise a load of the network node 110 or the wireless communications network 100 at the time of performing the random access procedure.

The sending in this Action 403 may be performed, based on one or more conditions, according to one or more first parameters. This may be understood to mean that the sending using the one or more first parameters may only be performed when the one or more conditions are met, e.g., when the load in a cell wherein the first network node 131 is served by the network node 110 is high, that is, above a certain threshold. It may be that if such one or more conditions are not met, for example, if the load is low, the first wireless device 131 may be enabled to use the one or more second parameters, e.g., the legacy parameters, or parameters for non-limited wireless devices, so that the restricted access parameters may only be applied when needed.

The sending in this Action 403 may be performed, e.g., via the first link 141.

By sending the first message to the network node 110 according to the one or more first parameters, the random access procedure to access the wireless communications network 100 may be enabled to be more restrictive to the first wireless device 131, e.g., a RedCap UE, in comparison the one or more second wireless devices 132, which may be non-limited. This may be understood to enable to protect or prioritize the performance of legacy or normal capability wireless devices. This may therefore enable that in case of an overload situation, such as radio resource congestion or shortage of processing capabilities, the network node 110 may be enabled to reduce overload by denying access to a cell to low complexity UEs such as the first wireless device 131. Hence, the performance of the wireless communications network 100 may be optimized, ensuring that service to higher priority wireless devices is provided.

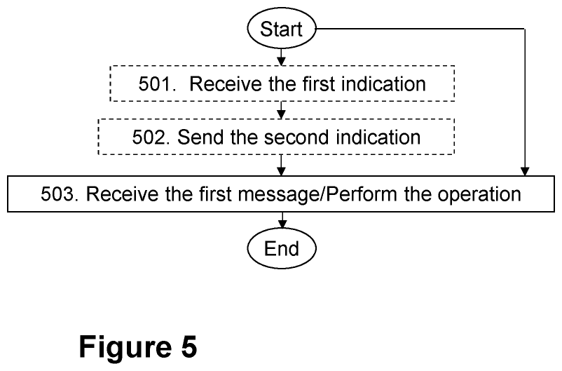

Embodiments of a method performed by the network node 110, will now be described with reference to the flowchart depicted in FIG. 5. The method may be understood to be for handling access to the wireless communications network 100. The network node 110 may be understood to operate in the wireless communications network 100.

In some examples, the wireless communications network 100 may support at least one of: New Radio (NR), Long Term Evolution (LTE), LTE for Machines (LTE-M), enhanced Machine Type Communication (eMTC), and Narrow Band Internet of Things (NB-IOT).

The method may be understood to be a computer-implemented method.

The method may comprise one or more of the following actions. Several embodiments are comprised herein. In some embodiments, all the actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the network node 110 is depicted FIG. 5.

The detailed description of some of the following corresponds to the same references provided above, in relation to the actions described for the first wireless device 131, and will thus not be repeated here to simplify the description. For example, in some examples, the first wireless device 131 may be a wireless device with reduced capacity, e.g., a RedCap UE.

### Action 501

In this Action 501, the network node 110 may receive the first indication from the first wireless device 131. The first indication may indicate that the first wireless device 131 has the one or more first features that are limited with respect to the one or more second features of one or more second wireless devices 132.

The receiving in this Action 501 may be performed, e.g., via the first link 141.

### Action 502

In this Action 502, the network node 110 may send the second indication to the first wireless device 131. The second indication may indicate at least one of: i) the one or more first parameters, and ii) the one or more conditions.

The sending in this Action 502, of the second indication may be to the first wireless device 131.

The one or more first parameters, in relation to the one or more second parameters, may comprise at least one of: i) the smaller group of preambles to select from, to transmit to the network node 110, ii) the shorter preamble space for Msg1 transmission to the network node 110, iii) the more infrequent PRACH resources, iv) the longer back-off time, v) the lower maximal number of RA attempts, vi) the reduced power control, vii) the lower priority for being granted access, and viii) the lower maximum number of Msg3 transmissions.

In some embodiments, the one or more first parameters may be indicated as one of: the absolute one or more values, the one or more offsets of the other one or more values, and the one or more factors to apply to the other one or more values.

In some embodiments, the sent second indication may be comprised in an RRC configuration message.

In some of such embodiments, the second indication may be comprised in one of: the RACH-ConfigCommonRedcap IE, the RA-Prioritization IE, the RACH-ConfigGeneric IE, and the RRCSetupRequest message.

### Action 503

In this Action 503, the network node 110 may initiate performing, or perform, an operation, e.g., the first operation or another operation, as part of the random access procedure to access the wireless communications network 100. As an example, this Action may comprise that the network node 110 receives the first message from the first wireless device 13 as the part of a random access procedure to access the wireless communications network 100. The first wireless device 131 has the one or more first features that are limited with respect to the one or more second features of the one or more second wireless devices 132. The receiving in this Action 503 is performed according to the one or more first parameters. The one or more first parameters are different than the one or more second parameters permitted to be used in the wireless communications network 100 by the one or more second wireless devices 132 when performing random access.

The receiving in this Action 503 may be performed, e.g., via the first link 141.

In some embodiments, the receiving in this Action 503 may be performed based the on one or more conditions. The one or more conditions may comprise the load of the network node 110 or the wireless communications network 100 at the time of performing the random access procedure.

The receiving in this Action 503 may be performed, based on the one or more conditions, according to the one or more first parameters.

As an summarized overview of the foregoing, embodiments herein may be understood to enable the possibility of separate configuration of UEs with limited features, such as reduced capability (RedCap) UEs for the random access procedure. In this way, a differentiation may be achieved and the access may be made more restrictive for the RedCap UEs than for the typically higher prioritized legacy/full capability UEs.

Certain embodiments disclosed herein may provide one or more of the following technical advantage(s), which may be summarized as follows. Embodiments herein, may be understood to introduce a mechanism to protect the performance of legacy/normal capability UEs in the system when RedCap UEs may be introduced.

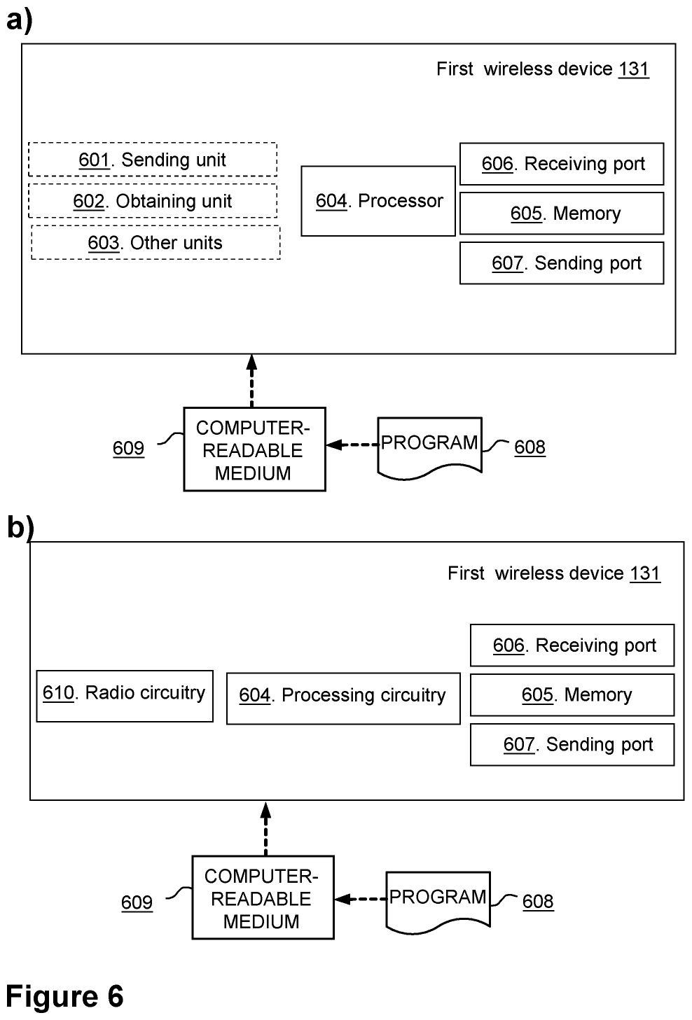

FIG. 6 depicts two different examples in panels a) and b), respectively, of the arrangement that the first wireless device 131 may comprise to perform the method actions described above in relation to FIG. 4. In some embodiments, the first wireless device 131 may comprise the following arrangement depicted in FIG. 6a. The first wireless device 131 may be understood to be for handling access to the wireless communications network 100. The first wireless device 131 may be understood to be configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first wireless device 131 and will thus not be repeated here. For example, the wireless device 130 may be configured to be a RedCap UE.

In FIG. 6, optional units are indicated with dashed boxes.

The first wireless device 131 is configured to perform the sending of Action 403, e.g. by means of a sending unit 601 within the first wireless device 131, configured to send the first message to the network node 110 as a part of the random access procedure to access the wireless communications network 100. The first wireless device 131 is configured to have the one or more first features that are configured to be limited with respect to the one or more second features of one or more second wireless devices 132. The sending is configured to be performed according to the one or more first parameters. The one or more first parameters are configured to be different than the one or more second parameters configured to be permitted to be used in the wireless communications network 100 by the one or more second wireless devices 132 when performing random access.

In some embodiments, the sending may be configured to be performed based on the one or more conditions. The one or more conditions may be configured to comprise the load of the network node 110 or the wireless communications network 100 at the time of performing the random access procedure.

The one or more first parameters, in relation to the one or more second parameters may be configured to comprise at least one of: i) the smaller group of preambles to select from, to transmit to the network node 110, ii) the shorter preamble space for Msg1 transmission to the network node 110, iii) the more infrequent PRACH resources, iv) the longer back-off time, v) the lower maximal number of RA attempts, vi) the reduced power control, vii) the lower priority for being granted access, and viii) the lower maximum number of Msg3 transmissions.

The first wireless device 131 may be configured to perform the sending of Action 401, e.g. by means of the sending unit 601 within the first wireless device 131, configured to send the first indication to the network node 110. The first indication may be configured to indicate the first wireless device 131 has the one or more first features that are configured to be limited with respect to one or more second features of one or more second wireless devices 132.

The first wireless device 131 may be configured to perform the obtaining of Action 402, e.g. by means of an obtaining unit 602, configured to obtain the second indication from at least one of the network node 110 and the memory of the first wireless device 131. The second indication may be configured to indicate at least one of: i) the one or more first parameters, and ii) the one or more conditions.

In some embodiments, the one or more first parameters may be configured to be indicated as one of: the absolute one or more values, the one or more offsets of other one or more values, and the one or more factors to apply to the other one or more values.

In some embodiments, the second indication configured to be obtained may be configured to be comprised in the RRC configuration message.

The second indication may be configured to be comprised in one of: the RACH-ConfigCommonRedcap information element, IE, the RA-Prioritization IE, the RACH-ConfigGeneric IE, and the RRCSetupRequest message.

Other units 603 may be comprised in the first wireless device 131.

The embodiments herein in the first wireless device 131 may be implemented through one or more processors, such as a processor 604 in the first wireless device 131 depicted in FIG. 6a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first wireless device 131. One such carrier may be in the form of a CD ROM disc. It is however feasible with other data carriers such as a memory stick. The computer program code may furthermore be provided as pure program code on a server and downloaded to the first wireless device 131.

The first wireless device 131 may further comprise a memory 605 comprising one or more memory units. The memory 605 is arranged to be used to store obtained information, store data, configurations, schedulings, and applications etc. to perform the methods herein when being executed in the first wireless device 131.

In some embodiments, the first wireless device 131 may receive information from, e.g., the network node 110, through a receiving port 606. In some embodiments, the receiving port 606 may be, for example, connected to one or more antennas in first wireless device 131. In other embodiments, the first wireless device 131 may receive information from another structure in the wireless communications network 100 through the receiving port 606. Since the receiving port 606 may be in communication with the processor 604, the receiving port 606 may then send the received information to the processor 604. The receiving port 606 may also be configured to receive other information.

The processor 604 in the first wireless device 131 may be further configured to transmit or send information to e.g., the network node 110, or another structure in the wireless communications network 100, through a sending port 607, which may be in communication with the processor 604, and the memory 605.

Those skilled in the art will also appreciate that the different units 601-603 described above may refer to a combination of analog and digital modules, and/or one or more processors configured with software and/or firmware, e.g., stored in memory, that, when executed by the one or more processors such as the processor 604, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 601-603 described above may be implemented as one or more applications running on one or more processors such as the processor 604.

Thus, the methods according to the embodiments described herein for the first wireless device 131 may be respectively implemented by means of a computer program 608 product, comprising instructions, i.e., software code portions, which, when executed on at least one processor 604, cause the at least one processor 604 to carry out the actions described herein, as performed by the first wireless device 131. The computer program 608 product may be stored on a computer-readable storage medium 609. The computer-readable storage medium 609, having stored thereon the computer program 608, may comprise instructions which, when executed on at least one processor 604, cause the at least one processor 604 to carry out the actions described herein, as performed by the first wireless device 131. In some embodiments, the computer-readable storage medium 609 may be a non-transitory computer-readable storage medium, such as a CD ROM disc, or a memory stick. In other embodiments, the computer program 608 product may be stored on a carrier containing the computer program 608 just described, wherein the carrier is one of an electronic signal, optical signal, radio signal, or the computer-readable storage medium 609, as described above.

The first wireless device 131 may comprise a communication interface configured to facilitate communications between the first wireless device 131 and other nodes or devices, e.g., the network node 110. The interface may, for example, include a transceiver configured to transmit and receive radio signals over an air interface in accordance with a suitable standard.

In other embodiments, the first wireless device 131 may comprise the following arrangement depicted in FIG. 6b. The first wireless device 131 may comprise a processing circuitry 604, e.g., one or more processors such as the processor 604, in the first wireless device 131 and the memory 605. The first wireless device 131 may also comprise a radio circuitry 610, which may comprise e.g., the receiving port 606 and the sending port 607. The processing circuitry 610 may be configured to, or operable to, perform the method actions according to FIG. 4, in a similar manner as that described in relation to FIG. 6a. The radio circuitry 610 may be configured to set up and maintain at least a wireless connection with the network node 110. Circuitry may be understood herein as a hardware component.

Hence, embodiments herein also relate to the first wireless device 131 comprising the processing circuitry 604 and the memory 605, said memory 605 containing instructions executable by said processing circuitry 604, whereby the first wireless device 131 is operative to perform the actions described herein in relation to the first wireless device 131, e.g., in FIG. 4.

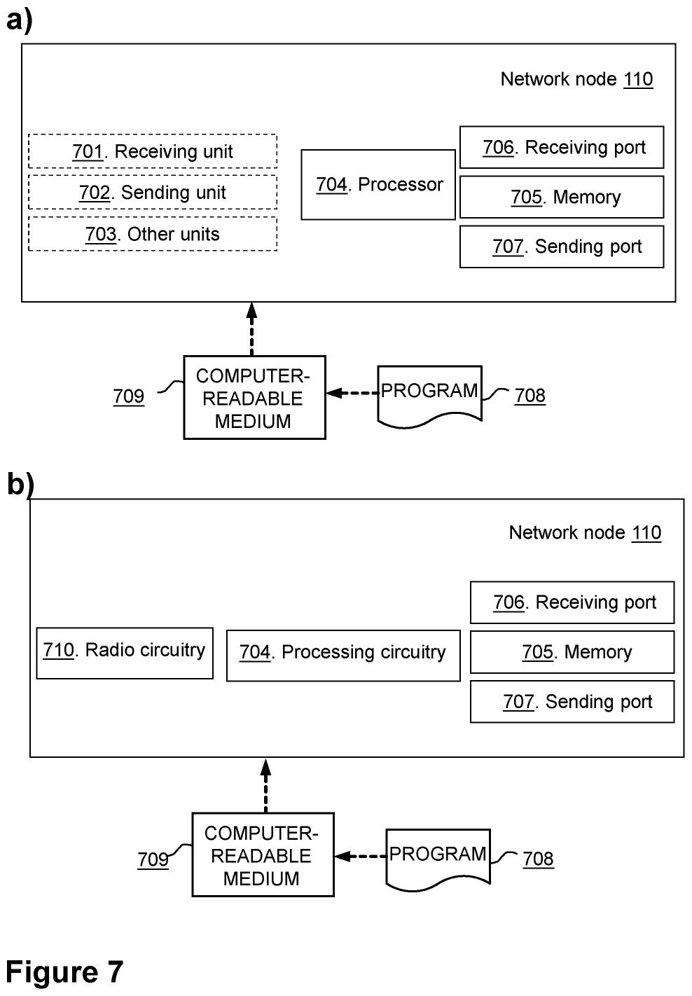

FIG. 7 depicts two different examples in panels a) and b), respectively, of the arrangement that the network node 110 may comprise to perform the method actions described above in relation to FIG. 5. In some embodiments, the network node 110 may comprise the following arrangement depicted in FIG. 7a. The network node 110 may be understood to be for handling access to the wireless communications network 100. The network node 110 may be understood to be configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first network node 111, and will thus not be repeated here. For example, the wireless device 130 may be configured to be a RedCap UE.

In FIG. 7, optional units are indicated with dashed boxes.

The network node 110 may be configured to perform the receiving of Action 503, e.g. by means of a receiving unit 701 within the network node 110, configured to receive the first message from the first wireless device 131 as a part of the random access procedure to access the wireless communications network 100. The first wireless device 131 is configured to have one or more first features that are configured to be limited with respect to one or more second features of one or more second wireless devices 132. The receiving is configured to be performed according to the one or more first parameters. The one or more first parameters are configured to be different than the one or more second parameters configured to be permitted to be used in the wireless communications network 100 by the one or more second wireless devices 132 when performing random access.

In some embodiments, the receiving may be configured to be performed based on the one or more conditions. The one or more conditions may be configured to comprise the load of the network node 110 or the wireless communications network 100 at the time of performing the random access procedure.

The one or more first parameters, in relation to the one or more second parameters may be configured to comprise at least one of: i) the smaller group of preambles to select from, to transmit to the network node 110, ii) the shorter preamble space for Msg1 transmission to the network node 110, iii) the more infrequent PRACH resources, iv) the longer back-off time, v) the lower maximal number of RA attempts, vi) the reduced power control, vii) the lower priority for being granted access, and viii) the lower maximum number of Msg3 transmissions.

The network node 110 may be configured to perform the receiving of Action 501, e.g. by means of the receiving unit 601 within the network node 110, configured to, receive the first indication from the first wireless device 131. The first indication may be configured to indicate the first wireless device 131 has the one or more first features that are configured to be limited with respect to one or more second features of one or more second wireless devices 132.

The network node 110 may be configured to perform the sending of Action 502, e.g. by means of a sending unit 602, configured to send the second indication to the first wireless device 131. The second indication may be configured to indicate at least one of: i) the one or more first parameters, and ii) the one or more conditions.

In some embodiments, the one or more first parameters may be configured to be indicated as one of: the absolute one or more values, the one or more offsets of the other one or more values, and the one or more factors to apply to the other one or more values.

In some embodiments, the second indication configured to be sent may be configured to be comprised in the RRC configuration message.

The second indication may be configured to be comprised in one of: the RACH-ConfigCommonRedcap information element, IE, the RA-Prioritization IE, the RACH-ConfigGeneric IE, and the RRCSetupRequest message.

Other units 703 may be comprised in the network node 110.

The embodiments herein in the network node 110 may be implemented through one or more processors, such as a processor 704 in the network node 110 depicted in FIG. 7a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 705 comprising one or more memory units. The memory 705 is arranged to be used to store obtained information, store data, configurations, schedulings, and applications etc. to perform the methods herein when being executed in the network node 110.

In some embodiments, the network node 110 may receive information from, e.g., the first wireless device 131 and/or the one or more second wireless devices 132, through a receiving port 706. In some embodiments, the receiving port 706 may be, for example, connected to one or more antennas in network node 110. In other embodiments, the network node 110 may receive information from another structure in the wireless communications network 100 through the receiving port 706. Since the receiving port 706 may be in communication with the processor 704, the receiving port 706 may then send the received information to the processor 704. The receiving port 706 may also be configured to receive other information.

The processor 704 in the network node 110 may be further configured to transmit or send information to e.g., the first wireless device 131, the one or more second wireless devices 132 and/or another structure in the wireless communications network 100, through a sending port 707, which may be in communication with the processor 704, and the memory 705.

Those skilled in the art will also appreciate that the different units 701-703 described above may refer to a combination of analog and digital modules, and/or one or more processors configured with software and/or firmware, e.g., stored in memory, that, when executed by the one or more processors such as the processor 704, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 701-703 described above may be implemented as one or more applications running on one or more processors such as the processor 704.

Thus, the methods according to the embodiments described herein for the network node 110 may be respectively implemented by means of a computer program 708 product, comprising instructions, i.e., software code portions, which, when executed on at least one processor 704, cause the at least one processor 704 to carry out the actions described herein, as performed by the network node 110. The computer program 708 product may be stored on a computer-readable storage medium 709. The computer-readable storage medium 709, having stored thereon the computer program 708, may comprise instructions which, when executed on at least one processor 704, cause the at least one processor 704 to carry out the actions described herein, as performed by the network node 110. In some embodiments, the computer-readable storage medium 709 may be a non-transitory computer-readable storage medium, such as a CD ROM disc, or a memory stick. In other embodiments, the computer program 708 product may be stored on a carrier containing the computer program 708 just described, wherein the carrier is one of an electronic signal, optical signal, radio signal, or the computer-readable storage medium 709, as described above.

The network node 110 may comprise a communication interface configured to facilitate communications between the network node 110 and other nodes or devices, e.g., the first wireless device 131. The interface may, for example, include a transceiver configured to transmit and receive radio signals over an air interface in accordance with a suitable standard.

In other embodiments, the network node 110 may comprise the following arrangement depicted in FIG. 7b. The network node 110 may comprise a processing circuitry 704, e.g., one or more processors such as the processor 704, in the network node 110 and the memory 705. The network node 110 may also comprise a radio circuitry 710, which may comprise e.g., the receiving port 706 and the sending port 707. The processing circuitry 704 may be configured to, or operable to, perform the method actions according to FIG. 5, in a similar manner as that described in relation to FIG. 7a. The radio circuitry 710 may be configured to set up and maintain at least a wireless connection with the first wireless device 131 and/or the one or more second wireless devices 132. Circuitry may be understood herein as a hardware component.

Hence, embodiments herein also relate to the network node 110 comprising the processing circuitry 704 and the memory 705, said memory 705 containing instructions executable by said processing circuitry 704, whereby the network node 110 is operative to perform the actions described herein in relation to the network node 110, e.g., in FIG. 5.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of: ” followed by a list of alternatives separated by commas, and wherein the last alternative is preceded by the “or” term.

### Examples Related to Embodiments Herein

Example 1. A method performed by a first wireless device (131), the method being for handling access to a wireless communications network (100), the method comprising:
sending (403) a first message to a network node (110) as a part of a random access procedure to access the wireless communications network (100), wherein:
i. the first wireless device (131) has one or more first features that are limited with respect to one or more second features of one or more second wireless devices (132), and
ii. the sending (403) is performed, based on one or more conditions, according to one or more first parameters, the one or more first parameters being different than one or more second parameters permitted to be used in the wireless communications network (100) by the one or more second wireless devices (132) when performing random access.

Example 2. The method according to example 1, wherein the one or more conditions comprise a load of the network node (110) or the wireless communications network (100) at the time of performing the random access procedure.

Example 3. The method according to any of examples 1-2, wherein the one or more first parameters, in relation to the one or more second parameters comprise at least one of:
i. a smaller group of preambles to select from, to transmit to the network node (110),
ii. a shorter preamble space for Msg1 transmission to the network node (110),
iii. more infrequent Physical Random Access Channel, PRACH, resources,
iv. a longer back-off time,
v. a lower maximal number of Random Access, RA, attempts,
vi. a reduced power control,
vii. a lower priority for being granted access, and
viii. a lower maximum number of Msg3 transmissions.

Example 4. The method according to any of examples 1-3, further comprising:
sending (401) a first indication to the network node (110), the first indication indicating the first wireless device (131) has the one or more first features that are limited with respect to one or more second features of one or more second wireless devices (132).

Example 5. The method according to any of examples 1-4, further comprising:
obtaining (402) a second indication from at least one of the network node (110) and a memory of the first wireless device (131), the second indication indicating at least one of:
i. the one or more first parameters, and
ii. the one or more conditions.

Example 6. The method according to example 5, wherein the one or more first parameters are indicated as one of:
absolute one or more values,
one or more offsets of other one or more values, one or more factors to apply to the other one or more values.

Example 7. The method according to any of examples 5-6, wherein the obtained second indication is comprised in a Radio Resource Control, RRC, configuration message.

Example 8. The method according to example 7, wherein the second indication is comprised in one of:
a RACH-ConfigCommonRedcap information element, IE,
an RA-Prioritization IE,
a RACH-ConfigGeneric IE, and”
an RRCSetupRequest message.

Example 9. The method according to any of examples 1-8, wherein the wireless device (130) is a RedCap UE.

Example 10. A method performed by a network node (110), the method being for handling access to a wireless communications network (100), the method comprising:
receiving (503) a first message from a first wireless device (131) as a part of a random access procedure to access the wireless communications network (100), wherein:
i. the first wireless device (131) has one or more first features that are limited with respect to one or more second features of one or more second wireless devices (132), and
ii. the receiving (503) is performed, based on one or more conditions, according to one or more first parameters, the one or more first parameters being different than one or more second parameters permitted to be used in the wireless communications network (100) by the one or more second wireless devices (132) when performing random access.

Example 11. The method according to example 10, wherein the one or more conditions comprise a load of the network node (110) or the wireless communications network (100) at the time of performing the random access procedure.

Example 12. The method according to any of examples 10-11, wherein the one or more first parameters, in relation to the one or more second parameters comprise at least one of:
i. a smaller group of preambles to select from, to transmit to the network node (110),
ii. a shorter preamble space for Msg1 transmission to the network node (110),
iii. more infrequent Physical Random Access Channel, PRACH, resources,
iv. a longer back-off time,
v. a lower maximal number of Random Access, RA, attempts,
vi. a reduced power control,
vii. a lower priority for being granted access, and
viii. a lower maximum number of Msg3 transmissions.

Example 13. The method according to any of examples 10-12, further comprising:
receiving (501) a first indication from the first wireless device (131), the first indication indicating the first wireless device (131) has the one or more first features that are limited with respect to one or more second features of one or more second wireless devices (132).

Example 14. The method according to any of examples 10-13, further comprising:
sending (502) a second indication to the first wireless device (131), the second indication indicating at least one of:
i. the one or more first parameters, and
ii. the one or more conditions.

Example 15. The method according to example 14, wherein the one or more first parameters are indicated as one of:
absolute one or more values,
one or more offsets of other one or more values, one or more factors to apply to the other one or more values.

Example 16. The method according to any of examples 14-15, wherein the sent second indication is comprised in a Radio Resource Control, RRC, configuration message.

Example 17. The method according to example 16, wherein the second indication is comprised in one of:
a RACH-ConfigCommonRedcap information element, IE,
an RA-Prioritization IE,
a RACH-ConfigGeneric IE, and”
an RRCSetupRequest message.

Example 18. The method according to any of examples 10-17, wherein the wireless device (130) is a RedCap UE.

### Further Extensions and Variations

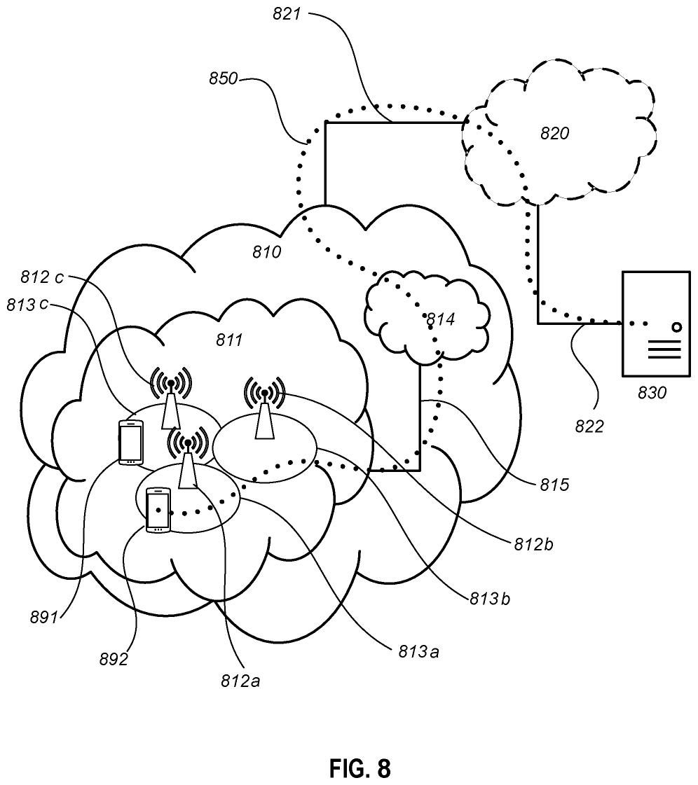

### FIG. 8: Telecommunication Network Connected via an Intermediate Network to a Host Computer in Accordance with Some Embodiments

With reference to FIG. 8, in accordance with an embodiment, a communication system includes telecommunication network 810 such as the wireless communications network 100, for example, a 3GPP-type cellular network, which comprises access network 811, such as a radio access network, and core network 814. Access network 811 comprises a plurality of network nodes such as the network node 110. For example, base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A plurality of user equipments, such as the first wireless device 131 and/or the one or more second wireless devices 132 are comprised in the wireless communications network 100. In FIG. 8, a first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812. Any of the UEs 891, 892 are examples of the first wireless device 131 and/or the one or more second wireless devices 132.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

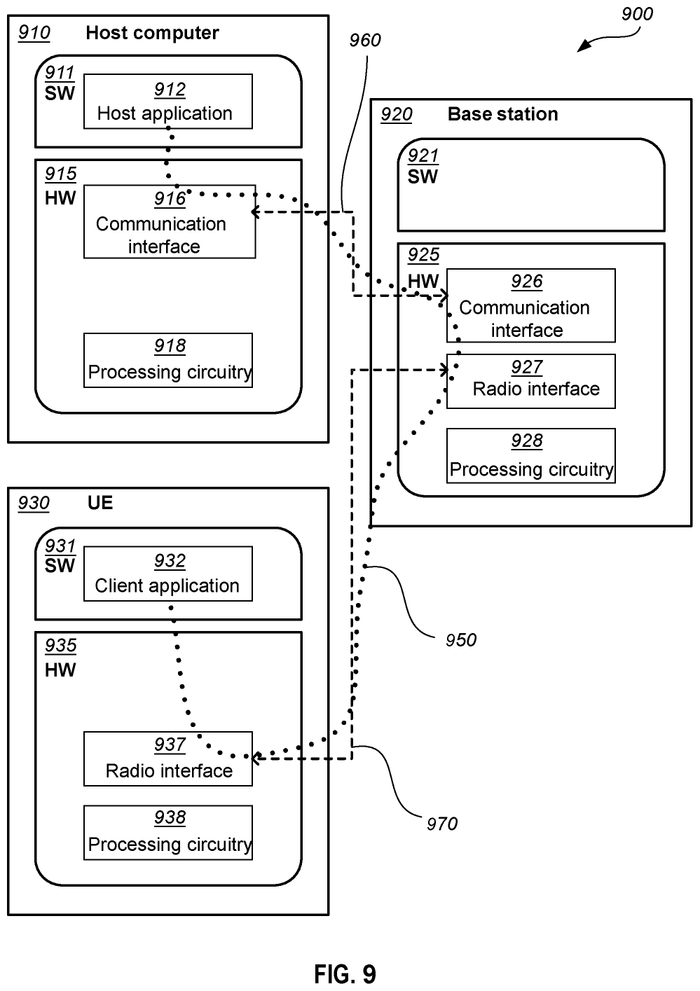

In relation to FIGS. 9, 10, 11, 12, and 13, which are described next, it may be understood that a UE is an example of the first wireless device 131 and/or the one or more second wireless devices 132, and that any description provided for the UE equally applies to the first wireless device 131 and/or the one or more second wireless devices 132. It may be also understood that the base station is an example of the network node 110, and that any description provided for the base station equally applies to the network node 110.

### FIG. 9: Host Computer Communicating via a Base Station with a User Equipment Over a Partially Wireless Connection in Accordance with Some Embodiments

Example implementations, in accordance with an embodiment, of the first wireless device 131 and/or the one or more second wireless devices 132, e.g., a UE, the network node 110, e.g., a base station and host computer discussed in the preceding paragraphs will now be described with reference to FIG. 9. In communication system 900, such as the wireless communications network 100, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes the network node 110, exemplified in FIG. 9 as a base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with the first wireless device 131 and/or the one or more second wireless devices 132, exemplified in FIG. 9 as a UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

The first wireless device 131 embodiments relate to FIG. 4, FIG. 6 and FIGS. 8-13.

The first wireless device 131 may comprise an interface unit to facilitate communications between the first wireless device 131 and other nodes or devices, e.g., the network node 110, the host computer 910, or any of the other nodes. In some particular examples, the interface may, for example, include a transceiver configured to transmit and receive radio signals over an air interface in accordance with a suitable standard.

The first wireless device 131 may comprise an arrangement as shown in FIG. 6 or in FIG. 9.

The first wireless device 131 may also be configured to communicate user data with a host application unit in a host computer 910, e.g., via another link such as 960.

The network node 110 embodiments relate to FIG. 5, FIG. 7 and FIGS. 8-13.

The network node 110 may comprise an interface unit to facilitate communications between the network node 110 and other nodes or devices, e.g., the first wireless device 131, the one or more second wireless devices 132, the host computer 1110, or any of the other nodes. In some particular examples, the interface may, for example, include a transceiver configured to transmit and receive radio signals over an air interface in accordance with a suitable standard.

The network node 110 may comprise an arrangement as shown in FIG. 7 or in FIG. 9.

The network node 110 may also be configured to communicate user data with a host application unit in a host computer 910, e.g., via another link such as 960.

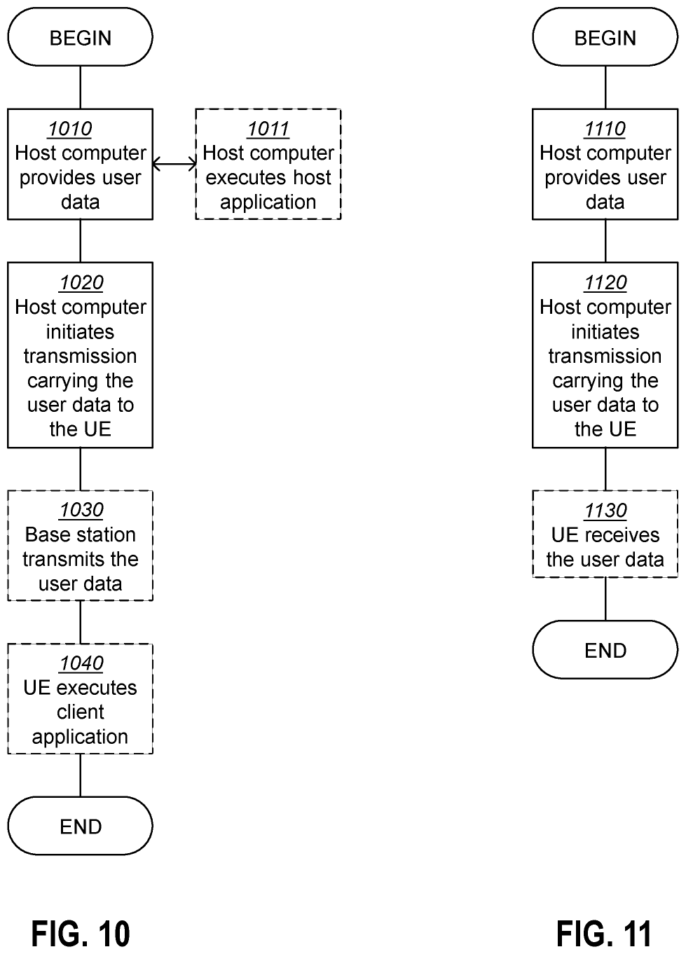

### FIG. 10: Methods Implemented in a Communication System Including a Host Computer, a Base Station and a User Equipment in Accordance with Some Embodiments

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

### FIG. 11: Methods Implemented in a Communication System Including a Host Computer, a Base Station and a User Equipment in Accordance with Some Embodiments

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

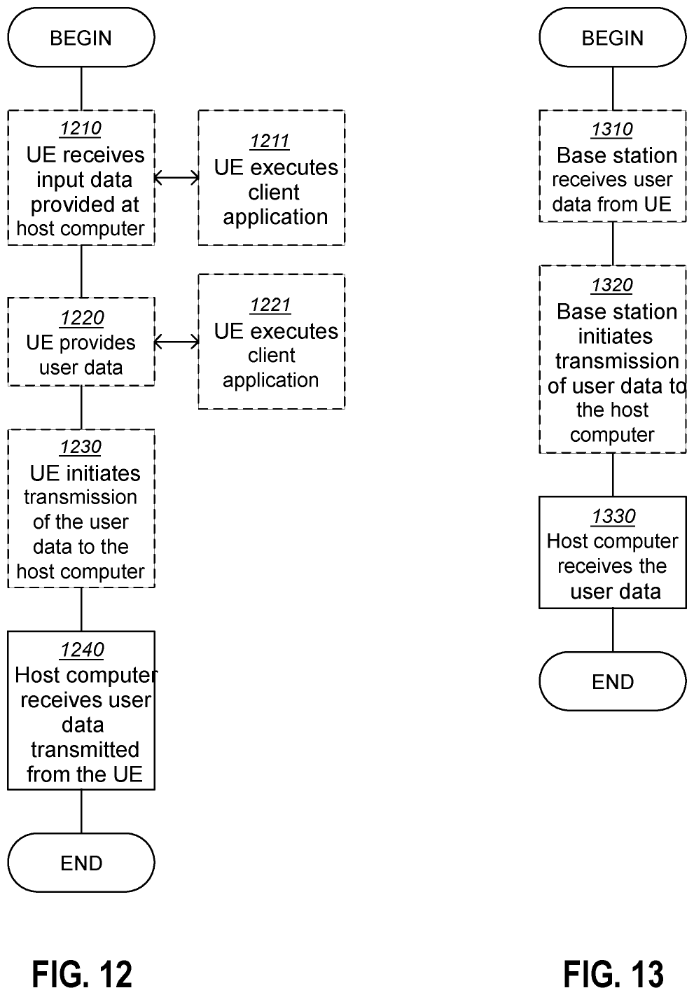

### FIG. 12: Methods Implemented in a Communication System Including a Host Computer, a Base Station and a User Equipment in Accordance with Some Embodiments

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

### FIG. 13: Methods Implemented in a Communication System Including a Host Computer, a Base Station and a User Equipment in Accordance with Some Embodiments

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.
5. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform one or more of the actions described herein as performed by the network node 110.
6. The communication system of embodiment 5, further including the base station.
7. The communication system of embodiment 6, further including the UE, wherein the UE is configured to communicate with the base station.
8. The communication system of embodiment 7, wherein:
   the processing circuitry of the host computer is configured to execute a host application, thereby providing the user data; and
   the UE comprises processing circuitry configured to execute a client application associated with the host application.
11. A method implemented in a base station, comprising one or more of the actions described herein as performed by the network node 110.
15. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs one or more of the actions described herein as performed by the network node 110.
16. The method of embodiment 15, further comprising:
   at the base station, transmitting the user data.
17. The method of embodiment 16, wherein the user data is provided at the host computer by executing a host application, the method further comprising:
   at the UE, executing a client application associated with the host application.
21. A user equipment (UE) configured to communicate with a base station, the UE comprising a radio interface and processing circuitry configured to perform one or more of the actions described herein as performed by the first wireless device 131.
25. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's processing circuitry configured to perform one or more of the actions described herein as performed by the first wireless device 131.
26. The communication system of embodiment 25, further including the UE.
27. The communication system of embodiment 26, wherein the cellular network further includes a base station configured to communicate with the UE.
28. The communication system of embodiment 26 or 27, wherein:
   the processing circuitry of the host computer is configured to execute a host application, thereby providing the user data; and
   the UE's processing circuitry is configured to execute a client application associated with the host application.
31. A method implemented in a user equipment (UE), comprising one or more of the actions described herein as performed by the first wireless device 131.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs one or more of the actions described herein as performed by the first wireless device 131.
36. The method of embodiment 35, further comprising:
   at the UE, receiving the user data from the base station.
41. A user equipment (UE) configured to communicate with a base station, the UE comprising a radio interface and processing circuitry configured to perform one or more of the actions described herein as performed by the first wireless device 131.
45. A communication system including a host computer comprising:
   a communication interface configured to receive user data originating from a transmission from a user equipment (UE) to a base station,
   wherein the UE comprises a radio interface and processing circuitry, the UE's processing circuitry configured to: perform one or more of the actions described herein as performed by the first wireless device 131.
46. The communication system of embodiment 45, further including the UE.
47. The communication system of embodiment 46, further including the base station, wherein the base station comprises a radio interface configured to communicate with the UE and a communication interface configured to forward to the host computer the user data carried by a transmission from the UE to the base station.
48. The communication system of embodiment 46 or 47, wherein:
   the processing circuitry of the host computer is configured to execute a host application; and
   the UE's processing circuitry is configured to execute a client application associated with the host application, thereby providing the user data.
49. The communication system of embodiment 46 or 47, wherein:
   the processing circuitry of the host computer is configured to execute a host application, thereby providing request data; and
   the UE's processing circuitry is configured to execute a client application associated with the host application, thereby providing the user data in response to the request data.
51. A method implemented in a user equipment (UE), comprising one or more of the actions described herein as performed by the first wireless device 131.
52. The method of embodiment 51, further comprising:
   providing user data; and
   forwarding the user data to a host computer via the transmission to the base station.
55. A method implemented in a communication system including a host computer, a base station and a user equipment (UE), the method comprising:
   at the host computer, receiving user data transmitted to the base station from the UE, wherein the UE performs one or more of the actions described herein as performed by the first wireless device 131.
56. The method of embodiment 55, further comprising:
   at the UE, providing the user data to the base station.
57. The method of embodiment 56, further comprising:
   at the UE, executing a client application, thereby providing the user data to be transmitted; and
   at the host computer, executing a host application associated with the client application.
58. The method of embodiment 56, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
61. A base station configured to communicate with a user equipment (UE), the base station comprising a radio interface and processing circuitry configured to perform one or more of the actions described herein as performed by the network node 110.
65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.
66. The communication system of embodiment 65, further including the base station.
67. The communication system of embodiment 66, further including the UE, wherein the UE is configured to communicate with the base station.
68. The communication system of embodiment 67, wherein:
   the processing circuitry of the host computer is configured to execute a host application;
   the UE is configured to execute a client application associated with the host application, thereby providing the user data to be received by the host computer.
71. A method implemented in a base station, comprising one or more of the actions described herein as performed by the network node 110.
75. A method implemented in a communication system including a host computer, a base station and a user equipment (UE), the method comprising:
   at the host computer, receiving, from the base station, user data originating from a transmission which the base station has received from the UE, wherein the UE performs one or more of the actions described herein as performed by the first wireless device 131.
76. The method of embodiment 75, further comprising:
   at the base station, receiving the user data from the UE.
77. The method of embodiment 76, further comprising:
   at the base station, initiating a transmission of the received user data to the host computer.

### REFERENCES

1. TS 38.331, NR RRC protocol specification, v15.8.0
2. TS 38.321, NR; Medium Access Control (MAC) protocol specification, v16.0.0

1-36. (canceled)

37. A method for handling access to a wireless communications network, performed by a first wireless device, the method comprising:
sending, to a network node and as part of a random access procedure to access the wireless communication network, a message according to one or more first parameters, the one or more first parameters being different than one or more second parameters permitted to be used in the wireless communications network by one or more second wireless devices when performing random access, wherein the one or more first parameters, relative to the one or more second parameters, comprise at least one of:
a longer back-off time,
a lower maximal number of random access attempts,
a reduced power control,
a lower priority for being granted access, or
a lower maximum number of Msg3 transmissions; and
wherein the first wireless device has one or more first features that are limited with respect to the one or more second features of the one or more second wireless devices.

38. The method of claim 37, wherein the sending is performed based on one or more conditions, wherein the one or more conditions comprise:
a load of the network node or the wireless communications network at the time of performing the random access procedure.

39. The method of claim 37, wherein the one or more first parameters, in relation to the one or more second parameters further comprise at least one of:
a smaller group of preambles to select from, to transmit to the network node,
a shorter preamble space for Msg1 transmission to the network node, or
more infrequent physical random access channel resources.

40. The method of claim 37, further comprising:
sending a first indication to the network node, the first indication indicating the first wireless device has the one or more first features that are limited with respect to one or more second features of one or more second wireless devices.

41. The method of claim 37, further comprising:
obtaining a second indication from at least one of the network node and a memory of the first wireless device, the second indication indicating at least one of:
the one or more first parameters, or
the one or more conditions.

42. The method of claim 41, wherein the one or more first parameters are indicated as one of:
absolute one or more values,
one or more offsets of other one or more values, or
one or more factors to apply to the other one or more values.

43. The method of claim 41, wherein the second indication is obtained from the network node, and wherein the obtained second indication is comprised in a radio resource control configuration message.

44. The method of claim 43, wherein the second indication is comprised in one of:
a RACH-ConfigCommonRedcap information element (IE),
an RA-Prioritization IE,
a RACH-ConfigGeneric IE, or
an RRCSetupRequest message.

45. The method of claim 43, wherein the first wireless device is a reduced capability user equipment.

46. A method for handling access to a wireless communications network, performed by a network node, the method comprising:
receiving, from a first wireless device and as part of a random access procedure to access the wireless communication network, a message according to one or more first parameters, the one or more first parameters being different than one or more second parameters permitted to be used in the wireless communications network by the one or more second wireless devices when performing random access, wherein the one or more first parameters, in relation to the one or more second parameters comprise at least one of:
a longer back-off time,
a lower maximal number of random access attempts,
a reduced power control,
a lower priority for being granted access, or
a lower maximum number of Msg3 transmissions; and
wherein the first wireless device has one or more first features that are limited with respect to the one or more second features of the one or more second wireless devices.

47. The method of claim 46, wherein the receiving is performed based on one or more conditions, wherein the one or more conditions comprise a load of the network node or the wireless communications network at the time of performing the random access procedure.

48. The method of claim 46, wherein the one or more first parameters, in relation to the one or more second parameters further comprise at least one of:
a smaller group of preambles to select from, to transmit to the network node,
a shorter preamble space for Msg1 transmission to the network node, or
more infrequent physical random access channel resources.

49. The method of claims 46, further comprising:
receiving a first indication from the first wireless device, the first indication indicating the first wireless device has the one or more first features that are limited with respect to one or more second features of one or more second wireless devices.

50. The method of claim 46, further comprising:
sending a second indication to the first wireless device, the second indication indicating at least one of:
the one or more first parameters, or
the one or more conditions.

51. The method of claim 50, wherein the one or more first parameters are indicated as one of:
absolute one or more values,
one or more offsets of other one or more values, or
one or more factors to apply to the other one or more values.

52. The method of claim 50, wherein the sent second indication is comprised in a radio resource control configuration message.

53. The method of claim 52, wherein the second indication is comprised in one of:
a RACH-ConfigCommonRedcap information element (IE),
an RA-Prioritization IE,
a RACH-ConfigGeneric IE, or
an RRCSetupRequest message.

54. The method of claims 46, wherein the first wireless device is a reduced capability user equipment.

55. A first wireless device, comprising:
processing circuitry and memory comprising instructions executable by the processing circuitry whereby wireless device is configured to:
send, to a network node and as part of a random access procedure to access a wireless communication network, a message according to one or more first parameters, the one or more first parameters being different than one or more second parameters permitted to be used in the wireless communications network by one or more second wireless devices when performing random access, wherein the one or more first parameters, in relation to the one or more second parameters comprise at least one of:
a longer back-off time,
a lower maximal number of random access attempts,
a reduced power control,
a lower priority for being granted access, or
a lower maximum number of Msg3 transmissions; and
wherein the first wireless device has one or more first features that are limited with respect to the one or more second features of the one or more second wireless devices.

56. A network node, comprising:
processing circuitry and memory comprising instructions executable by the processing circuitry whereby the network node is configured to:
receive, from a first wireless device and as part of a random access procedure to access a wireless communications network, a message according to one or more first parameters, the one or more first parameters being different than one or more second parameters permitted to be used in the wireless communications network by one or more second wireless devices when performing random access, wherein the one or more first parameters, in relation to the one or more second parameters comprise at least one of:
a longer back-off time,
a lower maximal number of random access attempts,
a reduced power control,
a lower priority for being granted access, or
a lower maximum number of Msg3 transmissions; and
wherein the first wireless device has one or more first features that are limited with respect to one or more second features of the one or more second wireless devices.
